(19) United States
(12) Patent Application Publication
(10) Pub. No.: US 2025/0247904 A1
(43) Pub. Date: Jul. 31, 2025

(54) EFFICIENT SESSION MANAGEMENT FUNCTION SELECTION

(71) Applicant: T-Mobile USA, Inc., Bellevue, WA (US)

(72) Inventors: Swetha Gopisetti, Issaquah, WA (US); Suresh Thanneeru, Redmond, WA (US); Kunal Prakash Barawkar, Bothell, WA (US)

(21) Appl. No.: 18/425,015

(22) Filed: Jan. 29, 2024

(51) Int. Cl. H04W 76/12; H04W 48/18; H04W 76/11; H04W 80/10

(52) U.S. Cl. CPC H04W 76/12; H04W 48/18; H04W 76/11; H04W 80/10

(57) ABSTRACT

System and methods for selecting a session management function (SMF) for establishing a communications session for a user device based on the existing active communications sessions are described. An access management function (AMF) may determine if there are currently active communications sessions for the user device that are associated with an SMF capable of supporting a newly requested communications session. If so, the AMF may use that SMF to establish the newly requested communications session, bypassing the traditional use of an NRF and consolidating signaling for the UE to one SMF and related components. Otherwise, the AMF may use an NRF to identify an SMF and related components and establish the session using such information.

### BACKGROUND

The number of wireless communications devices (e.g., user devices such as mobile telephones, smartphones, tablets, laptops, etc.) and other types of computing devices connected via wireless communications networks has rapidly grown as the cost of such devices and network connectivity has decreased. Along with increases in the number and capability of devices, the variety of services available to such devices has also increased. For example, voice and Internet connectivity are both available on nearly all wireless communications devices available today. Thus, the networks servicing such devices are typically configured to provide multiple services to wireless communications devices. However, different services may have different requirements and configurations. For example, latency and delay may be more impactful to real-time communications services (e.g., voice and video calls) than to web browser applications. Because the requirements and configurations used to implement various types of services on a wireless communications network may differ between service types, it may be challenging to quickly and efficiently establish and operate different types of communications sessions based on such requirements and configurations in a single wireless network.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1A is a schematic diagram of an illustrative wireless communications network environment in which systems and methods for efficient session management function selection may be implemented, in accordance with examples of the disclosure.

FIG. 1B is another schematic diagram of the illustrative wireless communications network environment of FIG. 1A in which systems and methods for efficient session management function selection may be implemented, in accordance with examples of the disclosure.

FIG. 2 is a signal flow diagram of illustrative functions and communications that may be implemented in a wireless communications network in which systems and methods for efficient session management function selection may be implemented, in accordance with examples of the disclosure.

FIG. 3 is a signal flow diagram of illustrative functions and communications that may be implemented in a wireless communications network in which systems and methods for efficient session management function selection may be implemented, in accordance with examples of the disclosure.

FIG. 4 is a flow diagram of an illustrative process for performing efficient session management function selection, in accordance with examples of the disclosure.

FIG. 5 is a schematic diagram of illustrative components in an example user device that is configured for interacting with a wireless communications network that implements efficient session management function selection, in accordance with examples of the disclosure.

FIG. 6 is a schematic diagram of illustrative components in an example computing device that is configured for performing one or more aspects of efficient session management function selection, in accordance with examples of the disclosure.

### DETAILED DESCRIPTION

### Overview

This disclosure is directed in part to systems and techniques for performing session management function selection in wireless communications networks and other networks that perform wireless device registration and resource provisioning. Such networks include any networks that may facilitate wireless communications services for one or more wireless communications devices. Such networks include networks that support one or more 3GPP standards, including, but not limited to, Long Term Evolution (LTE) networks (e.g., 4G LTE networks) and New Radio (NR) networks (e.g., 5G NR networks). However, the disclosed systems and techniques may be applicable in any network or system in which a user device may request and receive access to communicate with one or more network and/or remote devices using any protocol.

In conventional systems, a wireless user device (e.g., mobile telephone, smartphone, user equipment (UE), etc.) may wirelessly communicate with a base station (e.g., gNodeB, eNodeB, NodeB, base transceiver station (BTS), etc.) to request wireless communications services, such as a packet data communication session between the user device and a data network (e.g., the Internet, an IP multimedia system or subsystem (IMS), etc.) to provide a specific type of service (e.g., voice service, video service, Internet service). Various operations may be performed by network components, devices, and/or functions to obtain or otherwise establish the requested services for the wireless user device. Such operations may include authenticating the wireless user device and/or a user of the device, authorizing the requested services for the device and/or user, registering the device at the various systems and functions needed to provide the requested services, etc.

For example, a UE may transmit a request for a packet data communications session (e.g., a request to establish a protocol data unit (PDU) session or a packet data network (PDN) connection) with a data network to a gNodeB. A communications session such as a PDU session or PDN connection, for example in a 5G network, may be an end-to-end communications session between a device (e.g., the UE) and a data network (e.g., the Internet, an IMS, etc.). Such connections or sessions may be referred to generally herein as “communications session” and may include, but are not limited to, any type of PDN connection, PDU session, and any other type of packet data communications connection or session. The gNodeB may relay or otherwise convey this communications session request to an access management function (AMF) in the core of the wireless network in which the gNodeB is configured. The AMF may interact with one or more other components to perform the operations needed to establish this communications session, such as authenticating the device and/or user, registering the UE with the network, etc. In a particular example, the AMF may interact with a session management function (SMF) to establish the communications session and/or obtain SMF-related information to be used for communications session establishment on behalf of the UE.

An SMF may perform various session establishment operations, such as determining and assigning particular functions and/or components to service the session, associating policies for the session, etc. In examples, an important function performed by an SMF may be providing the access information needed by the UE to communicate with a data network using the established session. The SMF provides this information to the AMF for relay to the gNodeB and ultimately to the UE requesting the PDU session. In 5G examples, the SMF data provided to the AMF and/or the gNodeB may include data indicating one or more user plane functions (UPFs) with which the UE, via the gNodeB, may communicate to exchange user data with one or more destination devices and/or networks. A UPF may be configured to communicate with user devices, such as UEs, using one or more particular protocols. For example, a UPF may be configured to communicate with user devices using IPv4, IPv6, or both.

In examples, to accommodate the various services available to user devices and the corresponding configurations that may be used to implement such services, a network provider may use network “slicing” to divide a physical network infrastructure into multiple virtual networks. Each such virtual network may be configured and operated independently of other virtual networks while using the same underlying physical network infrastructure and components. Each virtual network may be referred to as a “slice” and may be identified by a data network name (DNN). In various examples, a single DNN may identify a single slice (e.g., a single virtual network); however, in other examples, a single DNN may be used to identify multiple virtual networks (e.g., may be associated with multiple slices). In such examples, and others, individual slices may be identified by a slice identifier (“slice ID”) that may be distinct from a DNN. Thus, one DNN may be associated with and support multiple slices.

An SMF may be associated with one or more particular UPFs. For example, an SMF may be (e.g., statically) configured with information associated with one or more particular UPFs for which the SMF may facilitate communications session establishment (e.g., to establish sessions between user devices (via associated gNodeBs) and such UPFs).

In various examples, a network may include a repository component or function that is configured to store and provide current addresses, identification information, DNN and/or slice associations, and/or other connectivity information for the functions and/or components in the network. In response to receiving a request from a particular function in a network, a repository function may provide a current address (e.g., IP address) and/or other identifying information for another function to the requesting function. The requesting function may then use that address to communicate with the associated function to perform one or more operations. In 5G examples, such a repository function may be referred to as a network function (NF) repository function (NRF). These and other functions performing similar operations may be referred to generally herein as a “repository functions.” In various embodiments, for example, for load-sharing and/or redundancy purposes, multiple NRFs may be configured in “pools” of NRFs that may be queried by various components and/or functions in (e.g., particular portions of) a core of a wireless network.

When an AMF receives a communications session establishment request from a gNodeB on behalf of a UE, the AMF may query an NRF for SMF data based on the request. For example, a UE may request a PDN connection (e.g., establishment of a PDU session) from a gNodeB. The request from the UE may indicate the PDN-Type representing a particular protocol with which the UE may be configured to communicate (e.g., IPv4 or IPv6). The request from the UE may also, or instead, indicate a type or use of a PDU session (e.g., voice, video, Internet, etc.) requested by the UE. The gNodeB may relay or otherwise provide the request to an AMF.

In response to receiving an SMF query (or other request for SMF information) from an AMF, the NRF may determine one or more appropriate SMFs based on the request. For example, the NRF may determine one or more SMFs associated with the service or PDU session type indicated in the communications session establishment request. The NRF may determine the SMF based on determining the slice(s) and/or DNN associated with the service or PDU session type requested. The NRF may then respond to the SMF query by transmitting identifying information (e.g., IP address, hostname, supported DNN(s) and/or slice ID(s), etc.) for those SMF(s) to the AMF. In examples, an NRF may determine a set of SMFs associated with DNN(s) and/or slice ID(s) associated with the session type and/or service indicated in the SMF query from the AMF and reply with identifying information for those SMFs. The AMF may then select (e.g., randomly) one of these SMFs to use for establishing a communications session for the UE.

The AMF may receive information for multiple SMFs from the NRF. The AMF may then randomly or systematically (e.g., using round-robin selection) select an SMF to service a particular session request. In conventional systems, the AMF performs this SMF selection process for each request for a PDU session received, even if the request is received from a UE for which an earlier-established PDU session is in use. For example, a UE may request a PDU session for a voice call that may be ongoing. The UE may then, during the voice call, request establishment of another PDU session for another service (e.g., for Internet access for a web browser application). In such examples, the AMF may perform random or round-robin selection of an SMF for the second PDU session request (as it did for the first), which may result in the AMF selecting a different SMF for the second requested PDU session than was used for the initially requested PDU session. This may ultimately result in the UE using resources associated with two different SMFs for the two sessions once both are activated, thus resulting in using duplicative resources to provide service to the UE. For example, paging services and other signaling across various slices for the UE may be provided by two separate sets of resources associated with the two SMFs used to configure the two PDU sessions. This may result in inefficient and duplicative use of network resources for a single UE. As will be appreciated, a single UE may have more than two PDU sessions active at any one time, and therefore this inefficiency may increase if different SMFs are used for each of the multiple PDU sessions in use by the UE.

To address this inefficient selection of SMFs for an individual UE, the disclosed systems and methods provide a means for an AMF to store SMF information used to establish active PDU sessions for a particular UE and use that information to ensure that the UE is then assigned to the same UE for subsequent PDU sessions, regardless of whether the PDU sessions use the same or different network slices.

In various examples, an SMF may be configured to provide to an NRF its supported network slices and/or DNNs at registration. The NRF may then provide these supported network slices and/or DNNs with the SMF data in response to an SMF query from an AMF. Note that, in some examples, the AMF may store SMF data for use in servicing multiple PDU session requests and/or may request SMF data from the NRF in response to each PDU session request.

Upon receipt of a PDU session request from a UE, an AMF may determine whether a PDU session is currently active for that UE. If not, the AMF may select an SMF using conventional methods (random selection, round-robin, etc.) for the UE's requested PDU session, either from currently available SMF data and/or by requesting SMF data from an NRF. The AMF may then establish a communications session for the UE using the selected SMF. The AMF may store the SMF data for this PDU session, including storing any data that may be used to associate an SMF and UE along with supported slices and/or DNNs. As described in more detail herein, the AMF may store and associate, as SMF data, an identifier of the UE, a PDU session identifier, the SMF used for the PDU session, and/or a slice and/or DNN identifier associated with the PDU session (e.g., identifying the slice and/or DNN used to service the PDU session).

Upon receipt of a PDU session request from a UE, if the AMF determines that a PDU session is currently active for the UE requesting the session (e.g. based on current SMF data stored at or otherwise accessible to the AMF), the AMF may then determine whether the newly requested PDU session may be serviced by the SMF associated with the existing (e.g., currently active) PDU session established for that UE. For example, the AMF may determine whether the SMF associated with the existing PDU session for the UE is configured to manage the newly requested session. For instance, the newly requested PDU session may be for a service provided by a particular slice and/or DNN. The AMF may determine whether the SMF associated with the existing PDU session for the UE is configured to provide session management functions for PDU sessions for that particular slice and/or DNN. If so, the AMF may then use that SMF to establish the newly requested PDU session for the UE. The AMF may also augment its SMF data with data representing the newly established session, such as the identifier of the UE, a PDU session identifier, the SMF used for the PDU session, and/or a slice and/or DNN identifier associated with the PDU session (e.g., identifying the slice and/or DNN used to service the PDU session).

If the SMF associated with the existing PDU session for the UE is not configured to provide session management functions for PDU sessions for the particular slice and/or DNN needed for the newly requested PDU session, the AMF may revert to traditional methods of querying the NRF and/or otherwise selecting an SMF configured to handle the requested PDU session (also storing SMF data for that session and UE, once established).

When an AMF detects that a PDU session has ended or otherwise been terminated, the AMF may remove corresponding data representing that session from its SMF data. The AMF may maintain SMF data for all active sessions, but may promptly remove SMF data for sessions that are inactive to prevent the inadvertent reuse of an AMF for a session for a particular UE that actually has no active PDU session via that AMF.

By facilitating the use of the same SMF for a UE and associated communications session establishment operations for multiple sessions, the systems and methods described herein provide more efficient communications session establishment operations and reduced resource utilization. By minimizing the duplicative use of resources to perform paging and other signaling with a UE by using the same SMF and associated resources for multiple sessions, the systems and methods described herein can improve the performance and increase the efficiency of both network and user resources. For example, the methods and systems described herein may be more efficient and/or more robust than conventional techniques, as they may increase the speed of the communication session establishment process and reduce the wasting of resources on repeated signaling to the same UE via multiple PDU sessions using resources associated with multiple SMFs. That is, the methods and systems described herein provide a technological improvement over existing SMF selection and communications session establishment systems and processes by facilitating improved SMF determination with reduced resource duplication and increasing network efficiency by reducing the traffic associated with signaling a UE that has multiple currently active PDU sessions. In addition to improving the efficiency of network and device resource utilization, the systems and methods described herein can provide more robust systems by, for example, making more efficient use of network devices by reducing unnecessary and/or unproductive device and network signaling and processing associated with attempting to communicate with one UE using multiple, duplicative resources, thereby freeing network and device resources for more productive operations.

Illustrative environments, signal flows, and techniques for implementing systems and methods for efficient session management function selection are described below. However, the described systems and techniques may be implemented in other environments.

### Illustrative System Architecture

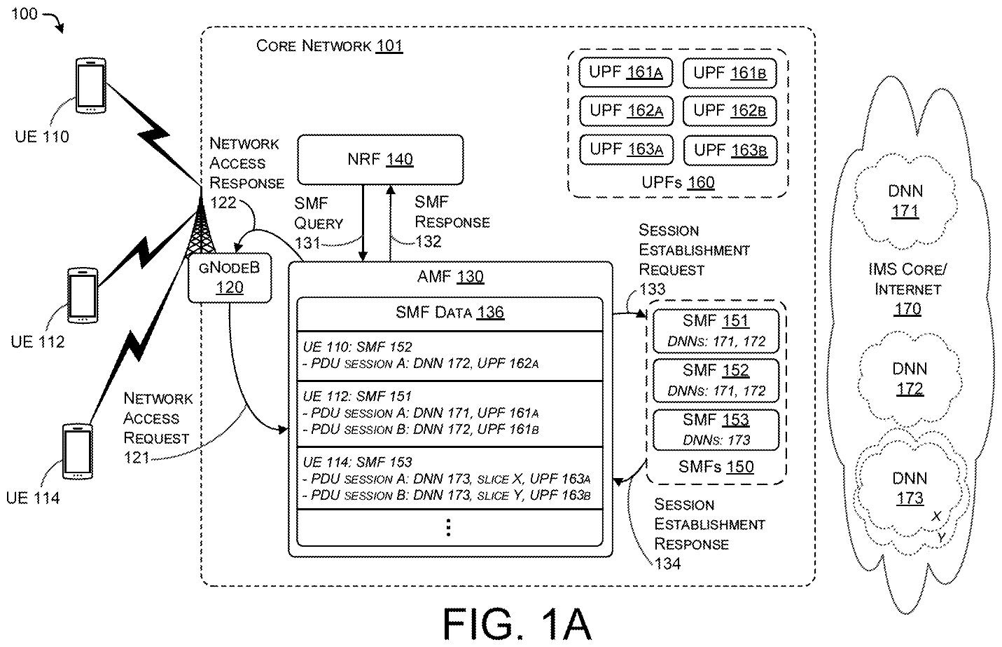

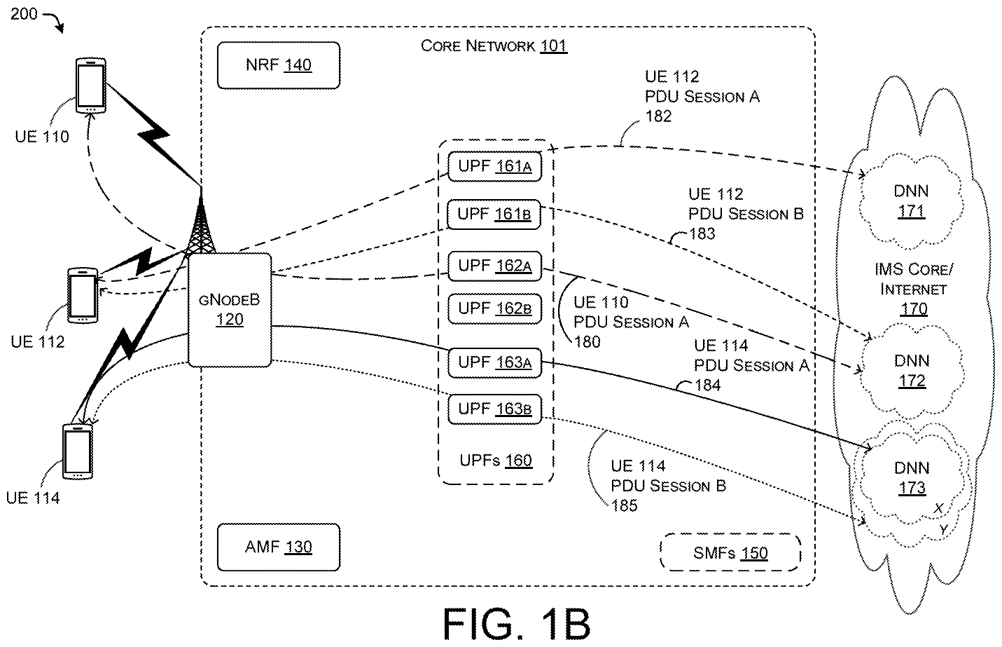

FIG. 1A is a schematic diagram of an illustrative wireless network environment 100 in which the disclosed systems and techniques may be implemented. The environment 100 may include a UE 110, a UE 112, and a UE 114 that may each wirelessly communicate with a gNodeB 120. While referred to as a “gNodeB” for explanatory purposes herein, the gNodeB 120 may be any type of base station, including, but not limited to, any type of BTS, NodeB, eNodeB, gNodeB, etc. The gNodeB 120 may communicate with other components and functions in a core network 101. The core network 101 may be any one or more networks that facilitate communications between particular devices, components, and/or functions of various types in the core of a wireless communications network that may facilitate communication between computing devices and/or mobile devices (e.g., UEs). Various connections between components and functions in the core network 101 may be wired, wireless, or a combination thereof. The components and functions described herein may be implemented as physical devices, as software components and/or functions executing on one or more computing devices, and as any combination thereof. In various embodiments, the core network 101 may facilitate the establishment of communications sessions (e.g., PDU sessions) for one or more wireless devices, such as any one or more of the UE 110, the UE 112, and the UE 114. In examples, the core network 101 may facilitate authorized packet-based communications between such wireless devices and other wireless devices, devices on the Internet, one or more IMSs, and/or one or more other data networks (DNS).

In FIG. 1, connections between components may be logical connections that may be facilitated by one or more wired and/or wireless connections and may include traversal of one or more devices, components, and/or functions that may or may not be shown in FIG. 1.

In environment 100, the one or more of the UE 110, UE 112, and UE 114 may communicate with the gNodeB 120 to request the establishment of a communications session (e.g., such as a PDU session) to communicate with one or more systems at or via an IMS Core/Internet 170. In response, the gNodeB 120 may relay the request or otherwise transmit a network access request 121 for the establishment of the communications session to an AMF 130. The network access request 121 may include an indication of a destination system and/or network and/or a PDU session type and/or a service indicator associated with the requested PDU session. In examples, the network access request 121 may also, or instead, include an indication of the requesting UE's PDN-Type, which may have been provided by the UE in the request to establish the communications session.

In various examples, the AMF 130 may interact with an NRF and/or other components of the core network 101 to determine the resources required to establish communications sessions for UEs. Such interactions may include authenticating and authorizing a user and/or user device (e.g., UE), creating contexts for such sessions, determining and applying session policies, establishing user plane resources, etc. In examples, the AMF 130, may query an NRF 140 with an SMF query 131 that may indicate data associated with the network access request 121. For example, the SMF query 131 may include an indication of the requesting UE's PDN-Type, the service and/or destination associated with the requested session, etc. Alternatively or additionally, the SMF query 131 may be more generic, requesting information more generally for (e.g., all) available SMFs.

The NRF 140 may respond to the SMF query 131 by transmitting an SMF response 132 to the AMF 130. The SMF response 132 may include one data indicating one or more SMFs and data associated therewith. For example, the SMF response 132 may include SMF addresses, supported slices and/or DNNs, supported PDN-Types, associated UPFs, etc.

The NRF 140 may acquire SMF data via SMF registration and updates performed by SMFs. For example, individual SMFs 151, 152, and 153 of the SMFs 150 may register with the NRF 140 and provide their associated DNNs and/or slices. In examples, the SMFs of the SMFs 150, when registering with the NRF 140, may also, or instead, indicate to the NRF 140 the PDN-Types that each of the SMFs 150 supports, their addresses, and/or any other suitable SMF data.

The SMFs 150 may individually be associated with one or more of the UPFs 160. For example, the SMF 151 may be associated with the UPFs 161a and 162b, the SMF 152 may be associated with the UPF 162, and the SMF 153 may be associated with the UPFs 163a and 163b. Individual UPFs of the UPFs 160 may support various slices and/or DNNs, and therefore the corresponding SMF of the SMFs 150 may support, or be considered to support, those slices and/or DNNs that are supported by its associated UPFs. For example, UPF 161a may facilitate the exchange of user data with a DNN 171 that may be a virtual network using the network infrastructure of the IMS core/Internet 170. UPF 161b may facilitate the exchange of user data with a DNN 172 that may be a virtual network using the network infrastructure of the IMS core/Internet 170. The SMF 151 associated with the UPF 161a and the UPF 161b may, therefore, be associated with session management for a PDU session between a UE and one of DNN 171 or DNN 172. Each of DNNs 171 and 172 may represent a particular virtual network or slice.

Continuing with this example, UPF 162a may facilitate the exchange of user data with a DNN 171, while UPF 162b may facilitate the exchange of user data with a DNN 172. The SMF 152 associated with the UPF 162a and UPF 162b may, therefore, be associated with session management for a PDU session between a UE and one of the DNN 171 or the DNN 172.

UPF 163a may facilitate the exchange of user data with a slice X of a DNN 173 that may be a virtual network using the network infrastructure of the IMS core/Internet 170. UPF 163b may facilitate the exchange of user data with a slice Y of the DNN 173. The SMF 153 associated with the UPFs 163a and 163b may, therefore, be associated with session management for a PDU session between a UE and one of slice X of DNN 173 or slice Y of DNN 173. As noted herein, and illustrated in this example, a DNN may support more than one slice of a network, such as the IMS core/Internet 170. Here, DNN 173 may support both slice X and slice Y of the IMS core/Internet 170.

The AMF 130 may maintain SMF data 136 that may represent active PDU sessions and related UE, SMF, slice, and/or DNN data for such sessions. For example, as shown here, the SMF data 136 may include data for UE 110 indicating that UE 110 currently has one active PDU session (UE 110 PDU session A) that is facilitating communication between UE 110 and DNN 172 and is associated with SMF 152. The SMF data 136 may also, or instead, include data for UE 112 indicating that UE 112 currently has two active PDU sessions (UE 112 PDU session A and UE 112 PDU session B), both of which are associated with SMF 151, and one of which is facilitating communication between UE 112 and DNN 171, while the other is facilitating communication between UE 112 and DNN 172. The SMF data 136 may also, or instead, include data for UE 114 indicating that UE 114 currently has two active PDU sessions (UE 114 PDU session A and UE 114 PDU session B), both of which are associated with SMF 153, and one of which is facilitating communication between UE 114 and slice X of DNN 173, while the other is facilitating communication between UE 114 and slice Y of DNN 173. The SMF data 136 may also, or instead, include any other data that may be useful in the disclosed systems and methods. For example, the SMF data 136 may include a session establishment time and/or a session duration that may be used to “time out” sessions from the SMF data 136, thereby removing “stale” sessions or sessions that are otherwise likely to have been terminated without explicit indications being provided to the AMF 130.

In examples, the AMF 130 may select an SMF from among the one or more SMFs (e.g., one or more of the SMFs 150) indicated in the SMF response 132 for use in establishing a PDU session for a UE that does not already have a PDU session indicated in the SMF data 136 and associated with an SMF capable of servicing the newly requested PDU session. The AMF 130 may then attempt to establish a communications session for the UE by transmitting a session establishment request 133 to the selected SMF. In response to the session establishment request 133, the selected SMF may transmit a session establishment response 134 reporting the success, failure, or other status of the session establishment. In examples, the session establishment request 133 may include any data that may facilitate establishing the requested communications session. The session establishment response 134 may include an indication that a session has been successfully established for the UE and may indicate one or more UPFs for use by the UE for user traffic. Alternatively, the session establishment response 134 may include an indication that the SMF failed to establish the session and one or more error codes and/or indications of failure types. For example, a session establishment response 134 may indicate that the selected SMF is not configured to establish communications sessions for the PDU session indicated in the session establishment request 133.

Alternatively, if the AMF 130 determines that the UE requesting a PDU session is indicated in the SMF data 136 as having a current active PDU session that is associated with an SMF capable of servicing the newly requested PDU session (e.g., associated with the appropriate slice and/or DNN), the AMF 130 may then attempt to establish a communications session for the UE by transmitting a session establishment request 133 to the SMF that is associated with the UE's existing active PDU session. Here again, the session establishment response 134 may be provided by the SMF that includes an indication that a session has been successfully established for the UE and may indicate one or more UPFs for the UE to use. Alternatively, the session establishment response 134 may include an indication that the SMF failed to establish the session and one or more error codes and/or indications of failure types. For example, a session establishment response 134 may indicate that the selected SMF is not configured to establish communications sessions for the PDU session indicated in the session establishment request 133.

In either case, the AMF 130 may transmit a network access response 122 to the gNodeB 120, for example, after setting up a communications session for the UE that requested the PDU session. The network access response 122 may include data that the gNodeB may provide to the UE for communicating with other systems and/or networks, such as one or more UPFs. The UE may then communicate, via the gNodeB 120, with one or more UPFs to exchange user data.

The process described above may be used to establish PDU sessions for the UE 110, the UE 112, and the UE 114. The SMF data for such sessions may be represented in the SMF data 136 of AMF 130. For example, and referring now to FIG. 1B, the AMF 130 may facilitate, with SMF 152, the establishment of the UE 110 PDU session A 180 that may be a communications session between the UE 110 and the DNN 172 facilitated via the UPF 162a to exchange user data. Because the UE 110 PDU session A 180 is the sole PDU session for the UE 110 that is currently active, the AMF 130 may have used conventional methods to determine the SMF 152 for establishing the session. Alternatively, the UE 110 PDU session A 180 may be the last remaining session for UE 110 of multiple co-active sessions, and therefore the AMF 130 may have selected the SMF 152 based on that SMF being used to establish a previously active session for the UE 110.

In another example, the AMF 130 may facilitate, with the SMF 151, the establishment of a UE 112 PDU session A 182 that may be a communications session between the UE 112 and the DNN 171 facilitated via the UPF 161a to exchange user data. The AMF 130 may further facilitate, with the SMF 151, the establishment of a UE 112 PDU session B 183 that may be a communications session between the UE 112 and the DNN 172 facilitated via the UPF 161b to exchange user data. In examples, the UE 112 PDU session A 182 may have been the first PDU session for the UE 112 that was activated (e.g., there were no other sessions active for the UE 112 when the session 182 was requested). Thus, the AMF 130 may have used conventional methods to determine the SMF 151 for establishing the UE 112 PDU session A 182. A request for establishment of a PDU session between UE 112 and the DNN 172 may have been subsequently received and, in response, the AMF 130 may have determined that the SMF 151 is already servicing a PDU session for the UE 112 and is capable of servicing a session between UE 112 and the DNN 172. Based upon this determination, the AMF 130 may have selected and interoperated with the SMF 151 to establish the UE 112 PDU session B 183 to exchange user data between the UE 112 and the DNN 172 via the UPF 161b.

In another example, the AMF 130 may facilitate, with the SMF 153, the establishment of a UE 114 PDU session A 184 that may be a communications session between the UE 114 and slice X of the DNN 173 facilitated via the UPF 163a to exchange user data. The AMF 130 may further facilitate, with the SMF 153, the establishment of a UE 114 PDU session B 185 that may be a communications session between the UE 114 and slice Y of the DNN 173 facilitated via the UPF 163b to exchange user data. In examples, the UE 114 PDU session A 184 may have been the first PDU session for the UE 114 that was activated (e.g., there were no other sessions active for the UE 114 when the session 184 was requested). Thus, the AMF 130 may have used conventional methods to determine the SMF 153 for establishing the UE 114 PDU session A 184. A request for establishment of a PDU session between UE 114 and slice Y of the DNN 173 may have been subsequently received and, in response, the AMF 130 may have determined that the SMF 153 is already servicing a PDU session for the UE 114 and is capable of servicing a session between UE 114 and slice Y of the DNN 173. Based upon this determination, the AMF 130 may have selected and interoperated with the SMF 153 to establish the UE 114 PDU session B 185 to exchange user data between the UE 114 and slice Y of the DNN 173 via the UPF 163b.

The UPFs associated with these sessions may facilitate the exchange of user data with the Internet and/or other devices or networks via the DNNs and/or slices of the IMS Core/Internet 170. Such data may be data for any service and/or application (e.g., voice, video, Internet, etc.) using any protocols (IPv4, IPv6, etc.).

### Illustrative Signal Flows

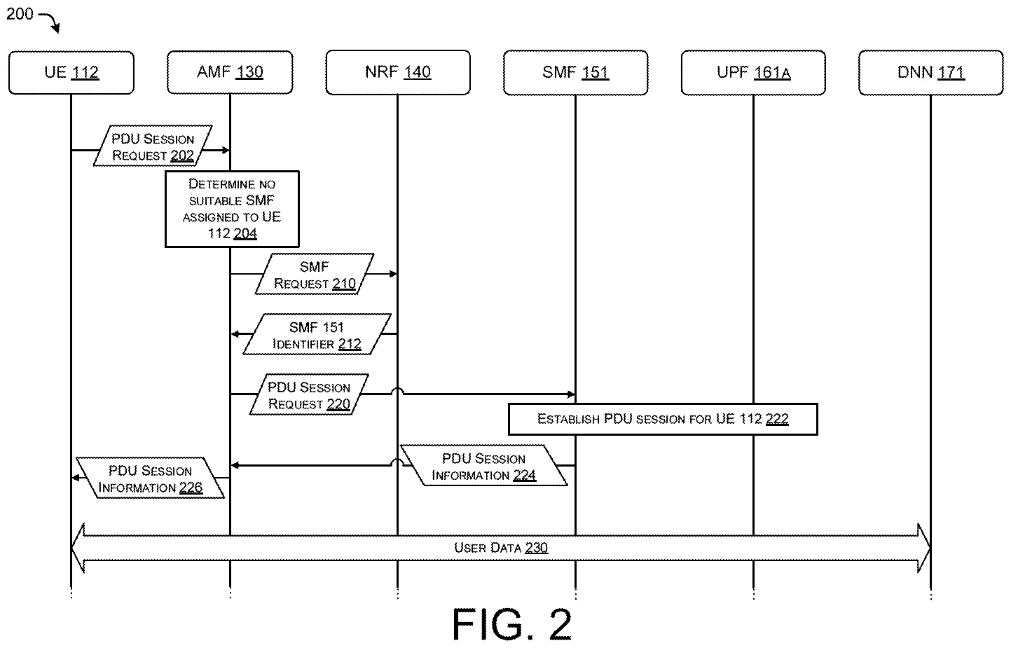

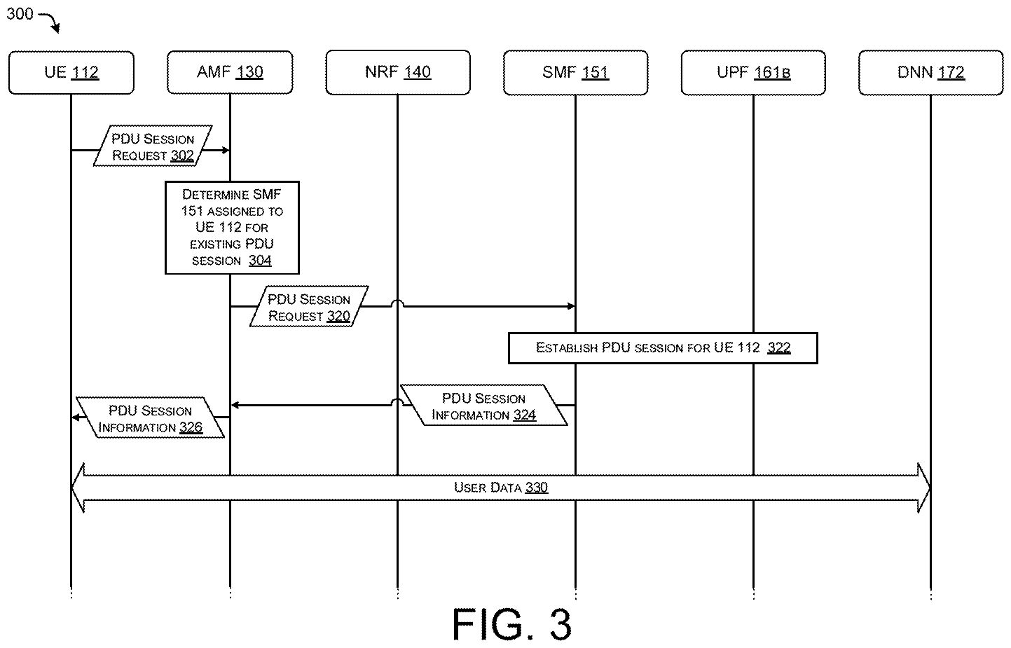

FIGS. 2 and 3 illustrate exemplary signal flows 200 and 300, respectively, of various messages that may be exchanged in one or more of the disclosed systems and techniques for efficiently selecting session management functions. Reference may be made in this description of the signal flows 200 and 300 to devices, entities, functions, components, and/or interfaces illustrated in FIGS. 1A and 1B and described in regard to those figures. However, the operations, signals, and signal flow illustrated in FIGS. 2 and 3 and described herein may be implemented in any suitable system and/or with any one or more suitable devices and/or entities. Moreover, any of the operations, signals, and/or entities described in regard to FIGS. 2 and 3 may be used separately and/or in conjunction with other operations, signals, and/or entities. All such embodiments are contemplated as within the scope of the instant disclosure.

Signal flow 200 of FIG. 2 illustrates an example of signals that may be exchanged and operations that may be performed based on a user device (UE 112) requesting the establishment of a PDU session between the user device and a destination system or network (e.g., generally referred to herein as a “destination”) according to systems and techniques disclosed herein. In this example, the UE 112 may transmit a communications request 202 (e.g., a PDU session request) to a wireless communications network where it may be received at the AMF 130. The communications request 202 may be any type of communications request, including a request to establish a packet-based communications session of any type (e.g., voice, video, Internet, etc.).

In response to receiving the request 202, the AMF 130 may determine, at operation 204, whether the AMF has stored data indicating that the UE 112 has a currently active PDU session initiated via the AMF 130 that is associated with an SMF capable of facilitating the establishment of the session requested by request 202. For example, the AMF 130 may determine if there are any SMFs already associated with the UE 112 that are capable of establishing a session between the UE 112 and the DNN or slice associated with the destination. In this example, the AMF 130 may determine, at operation 204, that there are no currently active PDU sessions for the UE 112 that are associated with an SMF suitable for the session requested by request 202.

Based on determining that there are no currently active PDU sessions for the UE 112 that are associated with an SMF suitable for the session requested by request 202, the AMF 130 may then request SMF information from the NRF 140 by transmitting an SMF request 210 to the NRF 140. This request 210 may include data that indicates the needed SMF capabilities (e.g., connectivity to a particular slice or DNN) or may be a general request for SMF information. The NRF 140 may respond with SMF information that may include an SMF 151 identifier 212 that may identify the SMF 151 as an SMF capable of establishing a session between the UE 112 and the DNN or slice associated with the destination indicated by the request 202. This SMF information may also include other SMF identifiers including, in some examples, identifiers for all available SMFs or, in other examples, identifiers only for SMFs capable of servicing the request 202.

The AMF 130 may then select the SMF 151 (e.g., randomly, round-robin, etc.) for establishing the session requested by request 202. The AMF 130 may transmit a PDU session request 220 to the SMF 151 requesting establishment of the session. This request may include data allowing the SMF 151 to determine an appropriate UPF (e.g., a UPF configured to provide service to a particular DNN or slice that may be capable of providing the service request by the request 202).

The SMF 151 may determine that UPF 161a is the appropriate UPF for the requested session, for example, based on determining that the DNN 171 will be the network associated with the destination indicated by the request 202. The SMF 151 may then perform operations 222 with the UPF 161a to establish the requested PDU session. Upon establishing the session, the SMF 151 may provide session information by transmitting PDU session information 224 to the AMF 130. Information 224 may include an indication of the UPF 161a (e.g., address, name, etc.).

The AMF 130 may then transmit PDU session information 226 to the UE 112 so that the UE 112 may begin exchanging user data via the newly established session. In examples, the AMF 130 may include an indication of the UPF 161a (e.g., address, name, etc.) in the information 226. The UE 112 may use this information to exchange user data 230 with the DNN 171 associated with the destination.

Signal flow 300 of FIG. 3 illustrates another example of signals that may be exchanged and operations that may be performed based on a user device (UE 112) requesting the establishment of a PDU session between the user device and a destination according to systems and techniques disclosed herein. In this example, the UE 112 may transmit a communications request 302 (e.g., a PDU session request) to a wireless communications network where it may be received at the AMF 130. The communications request 302 may be any type of communications request, including a request to establish a packet-based communications session of any type (e.g., voice, video, Internet, etc.).

In response to receiving the request 302, the AMF 130 may determine, at operation 304, whether the AMF has stored data indicating that the UE 112 has a currently active PDU session initiated via the AMF 130 that is associated with an SMF capable of facilitating the establishment of the session requested by request 302. For example, the AMF 130 may determine if there are any SMFs already associated with the UE 112 that are capable of establishing a session between the UE 112 and the DNN or slice associated with the destination. In this example, the AMF 130 may determine, at operation 304, that there is a currently active PDU session for the UE 112 that is associated with an SMF suitable for the session requested by request 302. For example, the signal flow 300 may occur after the signal flow 200 of FIG. 2 and the session established in the example of FIG. 2 may be active at the initiation of the signal flow 300 of FIG. 3. Thus, the AMF 130 may have a record (e.g., in its SMF data) of the session established by signal flow 200 using the SMF 151.

Based on determining that there is a currently active PDU session for the UE 112 that is associated with an SMF suitable for the session requested by request 302, the AMF 130 may bypass the use of the NRF 140 and instead determine the SMF information for the SMF associated with the currently active PDU session for the UE 112. In this example, that may be SMF 151. In examples, the AMF 130 may determine that the request 302 is associated with the DNN 172 (e.g. that the destination associated with the request 302 is available via DNN 172) and that the SMF 151 associated with an existing active session is configured to establish sessions using DNN 172. In response, the AMF 130 may select the SMF 151 for establishing the session requested by request 302 at operation 304.

The AMF 130 may transmit a PDU session request 320 to the SMF 151 requesting establishment of the session. This request may include data allowing the SMF 151 to determine an appropriate UPF (e.g., a UPF configured to provide service to a particular DNN or slice that may be capable of providing the service request by the request 302).

The SMF 151 may determine that UPF 161b is the appropriate UPF for the requested session, for example, based on determining that the DNN 172 will be the network associated with the destination indicated by the request 302. The SMF 151 may then perform operations 322 with the UPF 161b to establish the requested PDU session. Upon establishing the session, the SMF 151 may provide session information by transmitting PDU session information 324 to the AMF 130. Information 324 may include an indication of the UPF 161b (e.g., address, name, etc.).

The AMF 130 may then transmit PDU session information 326 to the UE 112 so that the UE 112 may begin exchanging user data via the newly established session. In examples, the AMF 130 may include an indication of the UPF 161b (e.g., address, name, etc.) in the information 326. The UE 112 may use this information to exchange user data 330 with the DNN 172 associated with the destination.

### Illustrative Operations

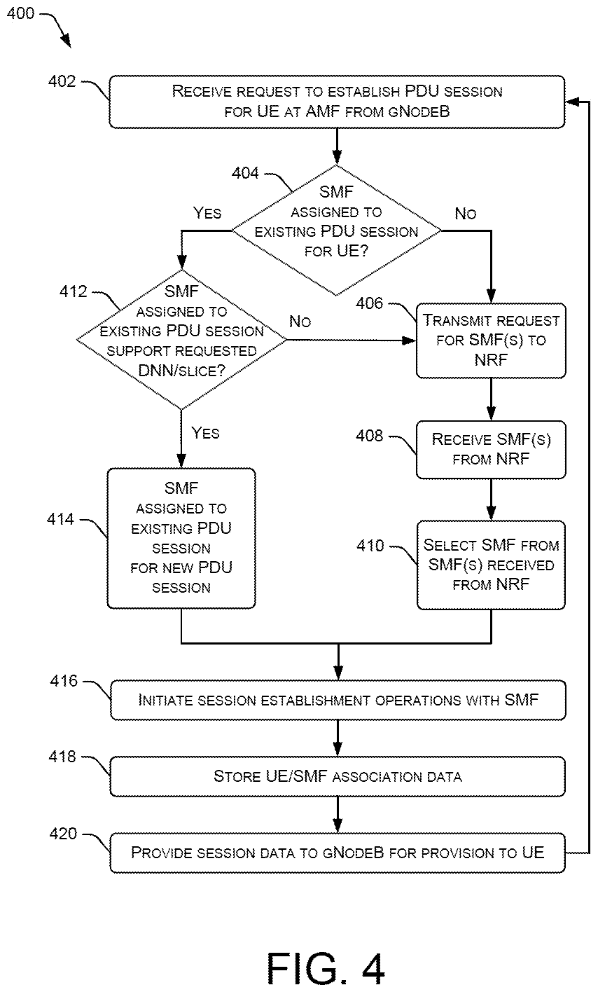

FIG. 4 shows a flow diagram of an illustrative process 400 for efficient session management function selection according to the disclosed embodiments. The process 400 is illustrated as a collection of blocks in a logical flow diagram, which represents a sequence of operations that can be implemented in software and executed in hardware. In the context of software, the blocks represent computer-executable instructions that, when executed by one or more processors, perform the recited operations. Generally, computer-executable instructions include routines, programs, objects, components, data structures, and the like that perform functions and/or implement particular abstract data types. The order in which the operations are described is not intended to be construed as a limitation, and any number of the described blocks can be omitted and/or combined in any order and/or in parallel to implement the processes. For discussion purposes, the process 400 may be described with reference to the wireless network environment 100 of FIGS. 1A and 1B, however, other environments may also be used.

At operation 402, an AMF (e.g., AMF 130) may receive a request to establish a PDU session from a gNodeB (e.g., gNodeB 120). The PDU session request may have originated at a user device (e.g., UE 110, UE 112, UE 114). The PDU session request may include or indicate a destination system or network and/or a type of PDU session (e.g., voice, video, web browsing, etc.).

At operation 404, the AMF may determine if there is an SMF assigned or otherwise associated with the UE with which the request received at 402 originated. For example, the AMF may evaluate its SMF data to determine whether there is a currently active PDU session established for the requesting UE. If not, the AMF may, at operation 406, transmit a request (e.g., SMF query 131) for SMF data to an NRF (e.g., NRF 140). This request may include or indicate request information, such as the destination indicated in the request, the type of service associated with the request, a slice and/or DNN associated with the destination and/or the request, etc. This request may instead be a general request for available SMFs and/or SMF information. At operation 408, the AMF may receive a response from the NRF that includes data representing one or more SMFs (e.g., one or more SMF addresses, hostnames, slices and/or DNNs serviced, services facilitated, etc.).

At operation 410, the AMF may select an SMF for use in establishing a communications session for the UE associated with the PDU session request received at operation 402. In examples, the AMF may select (e.g., randomly, round-robin) an SMF from the one or more SMFs received at operation 408 that are capable of establishing a session for the UE based on the request received at 402. For example, the AMF may randomly select, or perform round-robin selection of, an SMF from the set of SMFs provided by the NRF that are capable of establishing sessions between UEs and the slice and/or DNN associated with the destination indicated in the PDU session request.

At operation 416, the AMF may interoperate with the selected SMF to establish the requested PDU session. At operation 418, the AMF may store SMF data representing the now active PDU session for potential use in future requests for PDU sessions from the same UE that originated the newly established session. In examples, this stored SMF data may include indicators and/or data representing the UE associated with the session, the SMF used to establish the session, the slice associated with the session, the DNN associated with the session, one or more UPFs used to facilitate the sessions, and/or any other session and/or component data associated with the established active PDU session. At operation 420, the AMF may provide the session information to the gNodeB for providing to the requesting UE, and thereby allowing the UE to use the newly established PDU session for the exchange of user data.

If, returning to operation 404, the AMF determines that there is currently one or more active PDU sessions associated with the requesting UE (e.g., indicated in the AMF's SMF data), at operation 412, the AMF may determine if one or more such SMFs are capable of servicing the request received at operation 402. For example, an SMF assigned to a PDU session associated with the UE may or may not be capable of establishing a PDU session for the UE with a particular DNN or slice (e.g., SMFs may be configured to establish and manage sessions for particular DNNs and/or slices and not others). If the SMF(s) associated with the requesting UE is not configured to service the request received at operation 402, regardless of reason, then the process may move to operation 406 to determine an SMF using an NRF as described above.

If, at operation 412, the AMF determines that one or more SMFs associated with the requesting UE are configured to establish the requested PDU session, at operation 414, the AMF may select an SMF assigned to an existing PDU session for the UE to use for the newly requested session. In many examples, there may be just one SMF used for any sessions for the requesting UE, but in other examples, the AMF may randomly or round-robin select an SMF from among multiple SMFs that may be assigned to multiple corresponding sessions as indicated in the AMF's SMF data.

At operation 416, the AMF may interoperate with the selected SMF that is already associated with another session for the requesting UE to establish the requested PDU session. At operation 418, the AMF may store SMF data representing the now active PDU session with other SMF data and/or session information for the requesting UE. In examples, this stored SMF data may include indicators and/or data representing the UE associated with the session, the SMF used to establish the session, the slice associated with the session, the DNN associated with the session, one or more UPFs used to facilitate the sessions, a session establishment time, a session duration, and/or any other session and/or component data associated with the established active PDU session. At operation 420, the AMF may provide the session information to the gNodeB for providing to the requesting UE, and thereby allowing the UE to use the newly established PDU session for the exchange of user data. The process may return to operation 402 to receive and process subsequent requests for PDU sessions.

In summary, by more efficiently selecting session management functions and selectively avoiding using multiple session management functions for sessions for a same user device, the disclosed systems and techniques may increase the efficiency of usage of core network resources and other wireless network resources and improve the performance of both the network and user devices.

### Example User Equipment

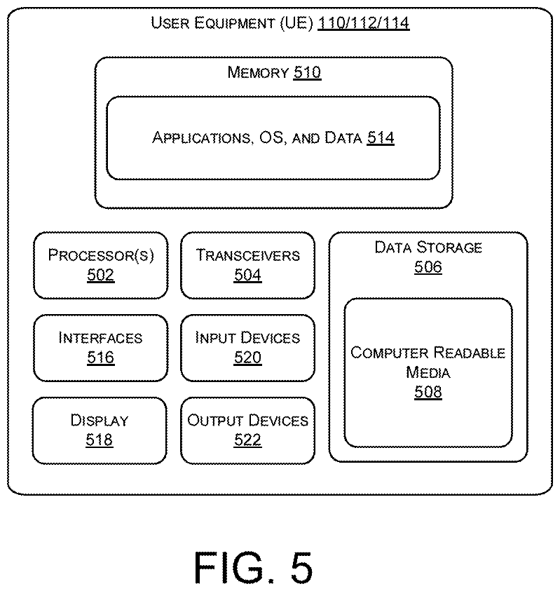

FIG. 5 is an example of a UE, such as one or more of the UE 110, the UE 112, and/or the UE 114, for use with the systems and methods disclosed herein, in accordance with some examples of the present disclosure. The UE 110/112/114 may include one or more processors 502, one or more transmit/receive antennas (e.g., transceivers or transceiver antennas) 504, and a data storage 506. The data storage 506 may include a computer-readable media 508 in the form of memory and/or cache. This computer-readable media may include a non-transitory computer-readable media. The processor(s) 502 may be configured to execute instructions, which can be stored in the computer-readable media 508 and/or in other computer-readable media accessible to the processor(s) 502. In some configurations, the processor(s) 502 is a Central Processing Unit (CPU), a Graphics Processing Unit (GPU), or both CPU and GPU, or any other sort of processing unit. The transceiver antenna(s) 504 can exchange signals with a base station, such as gNodeB 120.

The UE 110/112/114 may be configured with a memory 510. The memory 510 may be implemented within, or separate from, the data storage 506 and/or the computer-readable media 508. The memory 510 may include any available physical media accessible by a computing device to implement the instructions stored thereon. For example, the memory 510 may include, but is not limited to, RAM, ROM, EEPROM, a SIM card, flash memory or other memory technology, CD-ROM, DVD or other optical disk storage, magnetic cassettes, magnetic tape, magnetic disk storage or other magnetic storage devices, or any other medium which may be used to store the desired information and which may be accessed by the UE 110/112/114.

The memory 510 can store several modules, such as instructions, data stores, and so forth that are configured to execute on the processor(s) 502. In configurations, the memory 510 may also store one or more applications 514 configured to receive and/or provide voice, data and messages (e.g., SMS messages, Multi-Media Message Service (MMS) messages, Instant Messaging (IM) messages, Enhanced Message Service (EMS) messages, etc.) to and/or from another device or component (e.g., the gNodeB 120). The applications 514 may also include one or more operating systems and/or one or more third-party applications that provide additional functionality to the UE 110/112/114. The memory may also, or instead, store bandwidth information, such as UE-supported bands, bandwidth(s) and bandwidth parts, as well as communications session information such as UE-specific carrier bandwidth(s). The memory may also, or instead, store permit list and/or block list information, PDN-Type information, SMF information, UPF information, NRF information, etc.

Although not all illustrated in FIG. 5, the UE 110/112/114 may also comprise various other components, e.g., a battery, a charging unit, one or more network interfaces 516, an audio interface, a display 518, a keypad or keyboard, and one or more input devices 520, and one or more output devices 522.

### Example Computing Device

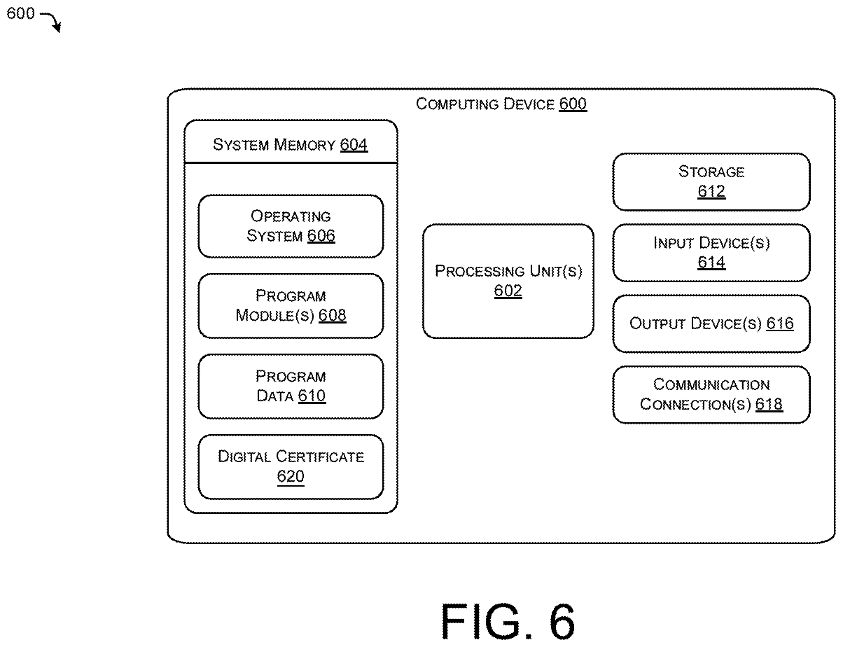

FIG. 6 is an example of a computing device 600 for use with the systems and methods disclosed herein, in accordance with some examples of the present disclosure. The computing device 600 can be used to implement various components of a core network, a base station (e.g., gNodeB 120, AMF 130, NRF 140, any of SMFs 150), and/or any servers, routers, gateways, gateway elements, administrative components, etc. that can be used by a communication provider. One or more computing devices 600 can be used to implement the core network 101, for example. One or more computing devices 600 can also be used to implement base stations and other components.

In various embodiments, the computing device 600 can include one or more processing units 602 and system memory 604. Depending on the exact configuration and type of computing device, the system memory 604 can be volatile (such as RAM), non-volatile (such as ROM, flash memory, etc.) or some combination of the two. The system memory 604 can include an operating system 606, one or more program modules 608, program data 610, and one or more digital certificates 620. The system memory 604 may be secure storage or at least a portion of the system memory 604 can include secure storage. The secure storage can prevent unauthorized access to data stored in the secure storage. For example, data stored in the secure storage can be encrypted or accessed via a security key and/or password.

The computing device 600 can also include additional data storage devices (removable and/or non-removable) such as, for example, magnetic disks, optical disks, or tape. Such additional storage is illustrated in FIG. 6 by storage 612. The computing device 600 may store, in either or both of the system memory 604 and the storage 612, PDU session information, SMF data, etc.

Non-transitory computer storage media of the computing device 600 can include volatile and nonvolatile, removable and non-removable media implemented in any method or technology for storage of information, such as computer-readable instructions, data structures, program modules, or other data. The system memory 604 and storage 612 are examples of computer-readable storage media. Non-transitory computer-readable storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by computing device 600. Any such non-transitory computer-readable storage media can be part of the computing device 600.

In various embodiments, any or all of the system memory 604 and storage 612 can store programming instructions which, when executed, implement some or all of the functionality described above as being implemented by one or more systems configured in the environment 100 and/or components of the network 101.

The computing device 600 can also have one or more input devices 614 such as a keyboard, a mouse, a touch-sensitive display, voice input device, etc. The computing device 600 can also have one or more output devices 616 such as a display, speakers, a printer, etc. can also be included. The computing device 600 can also contain one or more communication connections 618 that allow the device to communicate with other computing devices using wired and/or wireless communications.

### EXAMPLE CLAUSES

The following paragraphs describe various examples. Any of the examples in this section may be used with any other of the examples in this section and/or any of the other examples or embodiments described herein.

A: A method performed by a one or more computing devices configured in a wireless communications network, the method comprising: receiving, at access management function from a base station, a packet data communications session request comprising an indication of a user device and an indication of a destination; determining, at the access management function, a virtual network associated with the destination; determining, at the access management function, based on session management function data stored at the access management function, an active packet data communications session associated with the user device; determining, at the access management function, based on the session management function data, a session management function associated with the active packet data communications session associated with the user device; determining, at the access management function, that the session management function associated with the active packet data communications session is configured to establish packet data communications sessions with the virtual network; and initiating, at the access management function and interoperating with the session management function, based at least in part on determining that the session management function associated with the active packet data communications session is configured to establish the packet data communications sessions with the virtual network, establishment of a packet data communications session in the wireless communications network between the user device and the destination.

B: The method of paragraph A, wherein the active packet data communications session is associated with a second virtual network that is distinct from the virtual network associated with the destination.

C: The method of paragraph A or B, further comprising storing and associating, in the session management function data, data indicating the user device, the packet data communications session, and the session management function.

D: The method of any of paragraphs A-C, wherein determining the virtual network associated with the destination comprises determining a data network name for the virtual network.

E: The method of any of paragraphs A-D, wherein determining the virtual network associated with the destination comprises determining a slice identifier for the virtual network.

F: The method of any of paragraphs A-E, wherein initiating establishment of the packet data communications session comprises determining a user plane function for exchanging user data between the user device and the virtual network.

G: A network computing device configured at a wireless communications network, the network computing device comprising: one or more processors; one or more transceivers; and non-transitory computer-readable media storing computer-executable instructions that, when executed by the one or more processors, cause the one or more processors to perform operations comprising: receiving, from a base station, a packet data communications session request comprising an indication of a user device and an indication of a destination; determining a virtual network associated with the destination; determining, based on session management function data, an active packet data communications session associated with the user device; determining, based on the session management function data, a session management function associated with the active packet data communications session associated with the user device; determining that the session management function associated with the active packet data communications session is configured to establish packet data communications sessions with the virtual network; and initiating, with the session management function, based at least in part on determining that the session management function associated with the active packet data communications session is configured to establish the packet data communications sessions with the virtual network, establishment of a packet data communications session in the wireless communications network between the user device and the destination.

H: The network computing device of paragraph G, wherein the active packet data communications session is associated with a second virtual network that is distinct from the virtual network associated with the destination.

I: The network computing device of paragraph G or H, wherein the operations further comprise storing and associating, in the session management function data, data indicating the user device, the packet data communications session, and the session management function.

J: The network computing device of any of paragraphs G-I, wherein determining the virtual network associated with the destination comprises determining a data network name for the virtual network.

K: The network computing device of any of paragraphs G-J, wherein determining the virtual network associated with the destination comprises determining a slice identifier for the virtual network.

L: The network computing device of any of paragraphs G-K, wherein initiating establishment of the packet data communications session comprises determining a user plane function for exchanging user data between the user device and the virtual network.

M: The network computing device of any of paragraphs G-L, wherein: the packet data communications session request is received at a first time; and the operations further comprise: receiving, from the base station, at a second time prior to the first time, a second packet data communications session request comprising the indication of the user device and an indication of a second destination; determining a second virtual network associated with the second destination; determining, based on session management function data, that no active packet data communications session is associated with the user device; determining, based on interaction with network function repository function, the session management function; initiating, with the session management function, establishment of a second packet data communications session in the wireless communications network between the user device and the second destination; and storing and associating, in the session management function data, data indicating the user device, the second packet data communications session, and the session management function.

N: The network computing device of paragraph M, further comprising storing and associating with the data indicating the user device, the second packet data communications session, and the session management function in the session management function data, an indication of the second virtual network.

O: A non-transitory computer-readable media storing computer-executable instructions that, when executed by one or more processors, cause the one or more processors to perform operations comprising: receiving, at access management function from a base station, a packet data communications session request comprising an indication of a user device and an indication of a destination; determining, at the access management function, a virtual network associated with the destination; determining, at the access management function, based on session management function data stored at the access management function, an active packet data communications session associated with the user device; determining, at the access management function, based on the session management function data, a session management function associated with the active packet data communications session associated with the user device; determining, at the access management function, that the session management function associated with the active packet data communications session is configured to establish packet data communications sessions with the virtual network; and initiating, at the access management function and interoperating with the session management function, based at least in part on determining that the session management function associated with the active packet data communications session is configured to establish the packet data communications sessions with the virtual network, establishment of a packet data communications session between the user device and the destination.

P: The non-transitory computer-readable media of paragraph O, wherein the active packet data communications session is associated with a second virtual network that is distinct from the virtual network associated with the destination.

Q: The non-transitory computer-readable media of paragraph O or P, wherein the operations further comprise storing and associating, in the session management function data, data indicating the user device, the packet data communications session, and the session management function.

R: The non-transitory computer-readable media of any of paragraphs O-Q, wherein initiating establishment of the packet data communications session comprises determining a user plane function for exchanging user data between the user device and the virtual network.

S: The non-transitory computer-readable media of any of paragraphs O-R, wherein: the packet data communications session request is received at a first time; and the operations further comprise: receiving, from the base station, at a second time prior to the first time, a second packet data communications session request comprising the indication of the user device and an indication of a second destination; determining a second virtual network associated with the second destination; determining, based on session management function data, that no active packet data communications session is associated with the user device; determining, based on interaction with network function (NF) repository function (NRF), the session management function; initiating, with the session management function, establishment of a second packet data communications session between the user device and the second destination; and storing and associating, in the session management function data, data indicating the user device, the second packet data communications session, and the session management function.

T: The non-transitory computer-readable media of any of paragraphs O-S, wherein determining the virtual network associated with the destination comprises determining at least one of a data network name for the virtual network or a slice identifier for the virtual network.

While the example clauses described above are described with respect to one particular implementation, it should be understood that, in the context of this document, the content of the example clauses can also be implemented via a method, device, system, computer-readable medium, and/or another implementation. Additionally, any of the examples A-T can be implemented alone or in combination with any other one or more of the examples A-T.

### CONCLUSION

Depending on the embodiment, certain operations, acts, events, or functions of any of the algorithms described herein can be performed in a different sequence, can be added, merged, or left out altogether (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, components, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks, modules, and components described in connection with the embodiments disclosed herein can be implemented or performed by a machine, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The elements of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements, and/or states. Thus, such conditional language is not generally intended to imply that features, elements, and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Unless otherwise explicitly stated, articles such as “a” or “the” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes that come within the meaning and range of equivalency of the claims are to be embraced within their scope.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method performed by a one or more computing devices configured in a wireless communications network, the method comprising:
receiving, at access management function from a base station, a packet data communications session request comprising an indication of a user device and an indication of a destination;
determining, at the access management function, a virtual network associated with the destination;
determining, at the access management function, based on session management function data stored at the access management function, an active packet data communications session associated with the user device;
determining, at the access management function, based on the session management function data, a session management function associated with the active packet data communications session associated with the user device;
determining, at the access management function, that the session management function associated with the active packet data communications session is configured to establish packet data communications sessions with the virtual network; and
initiating, at the access management function and interoperating with the session management function, based at least in part on determining that the session management function associated with the active packet data communications session is configured to establish the packet data communications sessions with the virtual network, establishment of a packet data communications session in the wireless communications network between the user device and the destination.

2. The method of claim 1, wherein the active packet data communications session is associated with a second virtual network that is distinct from the virtual network associated with the destination.

3. The method of claim 1, further comprising storing and associating, in the session management function data, data indicating the user device, the packet data communications session, and the session management function.

4. The method of claim 1, wherein determining the virtual network associated with the destination comprises determining a data network name for the virtual network.

5. The method of claim 1, wherein determining the virtual network associated with the destination comprises determining a slice identifier for the virtual network.

6. The method of claim 1, wherein initiating establishment of the packet data communications session comprises determining a user plane function for exchanging user data between the user device and the virtual network.

7. A network computing device configured at a wireless communications network, the network computing device comprising:
one or more processors;
one or more transceivers; and
non-transitory computer-readable media storing computer-executable instructions that, when executed by the one or more processors, cause the one or more processors to perform operations comprising:
receiving, from a base station, a packet data communications session request comprising an indication of a user device and an indication of a destination;
determining a virtual network associated with the destination;
determining, based on session management function data, an active packet data communications session associated with the user device;
determining, based on the session management function data, a session management function associated with the active packet data communications session associated with the user device;
determining that the session management function associated with the active packet data communications session is configured to establish packet data communications sessions with the virtual network; and
initiating, with the session management function, based at least in part on determining that the session management function associated with the active packet data communications session is configured to establish the packet data communications sessions with the virtual network, establishment of a packet data communications session in the wireless communications network between the user device and the destination.

8. The network computing device of claim 7, wherein the active packet data communications session is associated with a second virtual network that is distinct from the virtual network associated with the destination.

9. The network computing device of claim 7, wherein the operations further comprise storing and associating, in the session management function data, data indicating the user device, the packet data communications session, and the session management function.

10. The network computing device of claim 7, wherein determining the virtual network associated with the destination comprises determining a data network name for the virtual network.

11. The network computing device of claim 7, wherein determining the virtual network associated with the destination comprises determining a slice identifier for the virtual network.

12. The network computing device of claim 7, wherein initiating establishment of the packet data communications session comprises determining a user plane function for exchanging user data between the user device and the virtual network.

13. The network computing device of claim 7, wherein:
the packet data communications session request is received at a first time; and
the operations further comprise:
receiving, from the base station, at a second time prior to the first time, a second packet data communications session request comprising the indication of the user device and an indication of a second destination;
determining a second virtual network associated with the second destination;
determining, based on session management function data, that no active packet data communications session is associated with the user device;
determining, based on interaction with network function repository function, the session management function;
initiating, with the session management function, establishment of a second packet data communications session in the wireless communications network between the user device and the second destination; and
storing and associating, in the session management function data, data indicating the user device, the second packet data communications session, and the session management function.

14. The network computing device of claim 13, further comprising storing and associating with the data indicating the user device, the second packet data communications session, and the session management function in the session management function data, an indication of the second virtual network.

15. A non-transitory computer-readable media storing computer-executable instructions that, when executed by one or more processors, cause the one or more processors to perform operations comprising:
receiving, at access management function from a base station, a packet data communications session request comprising an indication of a user device and an indication of a destination;
determining, at the access management function, a virtual network associated with the destination;
determining, at the access management function, based on session management function data stored at the access management function, an active packet data communications session associated with the user device;
determining, at the access management function, based on the session management function data, a session management function associated with the active packet data communications session associated with the user device;
determining, at the access management function, that the session management function associated with the active packet data communications session is configured to establish packet data communications sessions with the virtual network; and
initiating, at the access management function and interoperating with the session management function, based at least in part on determining that the session management function associated with the active packet data communications session is configured to establish the packet data communications sessions with the virtual network, establishment of a packet data communications session between the user device and the destination.

16. The non-transitory computer-readable media of claim 15, wherein the active packet data communications session is associated with a second virtual network that is distinct from the virtual network associated with the destination.

17. The non-transitory computer-readable media of claim 15, wherein the operations further comprise storing and associating, in the session management function data, data indicating the user device, the packet data communications session, and the session management function.

18. The non-transitory computer-readable media of claim 15, wherein initiating establishment of the packet data communications session comprises determining a user plane function for exchanging user data between the user device and the virtual network.

19. The non-transitory computer-readable media of claim 15, wherein:
the packet data communications session request is received at a first time; and
the operations further comprise:
receiving, from the base station, at a second time prior to the first time, a second packet data communications session request comprising the indication of the user device and an indication of a second destination;
determining a second virtual network associated with the second destination;
determining, based on session management function data, that no active packet data communications session is associated with the user device;
determining, based on interaction with network function (NF) repository function (NRF), the session management function;
initiating, with the session management function, establishment of a second packet data communications session between the user device and the second destination; and
storing and associating, in the session management function data, data indicating the user device, the second packet data communications session, and the session management function.

20. The non-transitory computer-readable media of claim 15, wherein determining the virtual network associated with the destination comprises determining at least one of a data network name for the virtual network or a slice identifier for the virtual network.
